(19) United States
(12) Patent Application Publication
(10) Pub. No.: US 2003/0220940 A1
(43) Pub. Date: Nov. 27, 2003

(54) Secure auditing of information systems

(75) Inventors: Ariel Futoransky, Buenos Aires (AR); Emiliano Kargieman, Buenos Aires (AR); Diego Ariel Bendersky, Buenos Aires (AR); Luciano Notarfrancesco, Buenos Aires (AR); Gerardo Gabriel Richarte, Buenos Aires (AR); Ivan Francisco Arce, Buenos Aires (AR); Alejo Sanchez, Buenos Aires (AR); Diego Ariel Aizemberg, Buenos Aires (AR)

Correspondence Address: FITZPATRICK CELLA HARPER & SCINTO, 30 ROCKEFELLER PLAZA, NEW YORK, NY, 10112, US

(73) Assignee: Core SDI, Incorporated, Boston, MA (US)

(21) Appl. No.: 10/414,120

(22) Filed: Apr. 15, 2003

Related U.S. Application Data
(60) Provisional application No. 60/372,164, filed on Apr. 15, 2002.

(51) Int. Cl. G06F 17/00

(52) U.S. Cl. 707/104.1

(57) ABSTRACT

A system and method are provided for analyzing audit log data. Text strings from a plurality of devices are stored in a log database, each of the text strings being indicative of an audit event in the respective device. At least a portion of the text strings are retrieved from the log database and the retrieved text strings are parsed according to pre-defined parsing rules. Each of the retrieved text strings is mapped to a respective audit event. The retrieved text strings are mapped based on the respective audit event. Representations of the filtered text strings are displayed on a grid using color-coded areas. The horizontal axis of the grid represents a first time scale and the vertical axis of the grid represents a second time scale different from the first time scale.

### CROSS-REFERENCE TO RELATED APPLICATIONS

This application claims the benefit of U.S. Provisional Application No. 60/372,164 filed Apr. 15, 2002.

### BACKGROUND OF THE INVENTION

1. Field of the Invention

The present invention relates generally to a system and method for providing secure auditing of computer information systems and, more particularly, to a system and method for accumulating and processing log data from various applications and platforms using encryption and authentication and presenting a visual representation of the data for analysis.

2. Related Art

In the last decades, society has experienced an explosive development of information technology and its application, in both the corporate and governmental sectors. Computer systems and computer networks are being used to store and manipulate a large amount of mission critical information and are replacing paper as the de-facto support media for the operations of any reasonably-sized organization. The associated boom in communications, the trend towards open systems, and the establishment of the Internet as a pervasive communication medium all have created an environment in which the risks associated with the critical nature of these computer networks and the profusion of threats to information stored on such networks tend to hinder the complete development of these new technologies and the fulfillment of goals of all type of organizations in modern society.

In this environment, information security plays an important role in the assessment of the technical risks associated with any significant corporate project. Consequently, there is a growing need for and reliance upon information security systems and professionals capable of implementing such systems. Network security auditing is an example of a process that is used to maintain and improve information security within an organization. It relies on tools and technologies that permit information security and information technology professionals identify and act upon events that posse a threat to the information security posture of the organization.

Information security assets such as servers, workstations, routers and switches and other devices deployed in a computer network use software and hardware components to monitor and record relevant events in their operating environment.

Generally these events are generated by the auditing subsystems of such IT assets and collected in system logs stored either locally or in remote facilities over the network. Events specifically related to information security are stored in these system logs intermixed with general-purpose events or kept in separate audit trails or security logs.

Special purpose information security IT assets, such as firewalls, intrusion detection systems (IDS), anti-virus software, authentication and authorization systems and vulnerability assessment tools can be used to monitor information technology assets and report on the status of their security, generating and maintaining their own security logs with relevant information security events.

The system and security logs pertaining to a given network may be collected and analyzed by a security auditor seeking to detect abnormalities that may indicate a violation of the organization's information security policy, a security breach or an attempted breach, and act upon it.

In the conventional auditing subsystems of present day operating systems, each security-related event is represented by a text entry in a database. The entry contains event identification information, such as the date and time at which the event was generated, the subsystem, application or user that generated it, a unique identifier number for the event and brief description of it. The entry also may contain a textual description providing the category of the event, e.g., “log-in failure”, and various codes indicating a type or reason for the event.

A system or security log may contain a large number of events for a given period of time of recorded events. Moreover, there may be a large number of permutations of each category of event due to the wide variety of possible users, types and reasons associated with each event. The shear amount and variety of information contained in the security log may be an impediment to the analysis of the log and detection of security breaches. The complexity associated with the collection and storage of many system and security logs across all IT assets in a computer network can hinder the auditing process due to scalability problems derived from the large amount of events generated by each IT asset and the great number of IT assets deployed in a typical organization's network.

Conventional security auditing tools typically provide text searching capabilities and simple charting and reporting facilities of system and security logs. Additionally, some of these tools provide rule-based parsing and statistical analysis of logs. For example, these tools may automatically parse, analyze and summarize system logs and generate reports and charts of aggregated events such as “users blocked due to bad password entry”, “number of failed log-in attempts over time” or “list of IT assets ordered by number of attempts to breach their security mechanisms” and multiple variations of charts and lists of such aggregated events.

However such conventional security auditing tools do not aid the auditor in detecting a wide range of attacks and security breaches which could be characterized by the generation of multiple events within a period of time spanning several IT assets in the computer network. These tools are also ineffective for the identification of patterns of events, such as usual log-in hour for the entire user population, generated by legitimate usage of IT assets in a network and detection of events that signal abnormal use, for the above example, such as unusual log-in hours for a specific user in the organization, possibly indicating an attempted security breach. The static and pre-defined nature of the analysis capabilities of conventional auditing tools make them limited and even unsuited for the detection of anything but the most simple forms of attack across IT assets of an organization. By using conventional auditing tools, an auditor can effectively detect known security problems or problems for which the tool used is pre-configured to identify and expose, but the auditor can not identify and understand security problems for which there is no previously known detection methodology.

### SUMMARY OF INVENTION

In view of the limitations of conventional auditing systems discussed above, the present invention provides a system and method for accumulating and processing log data from various applications and platforms and presenting a visual representation of the data for analysis. These capabilities enable the user to analyze large quantities of log data in an efficient, systematic manner, thus enabling the user to draw accurate conclusions regarding security vulnerabilities and failures.

In one aspect of the present invention, a system, method, and computer code are provided for analyzing audit log data. Text strings from a plurality of devices are stored in a log database, each of the text strings being indicative of an audit event in the respective device. At least a portion of the text strings are retrieved from the log database and the retrieved text strings are parsed according to pre-defined parsing rules. Each of the retrieved text strings is mapped to a respective audit event. The retrieved text strings are mapped based on the respective audit event. Representations of the filtered text strings are displayed on a grid using color-coded areas. The horizontal axis of the grid represents a first time scale and the vertical axis of the grid represents a second time scale different from the first time scale.

Embodiments of this aspect may include one or more of the following features. A group of the displayed areas may be selected and the grid resealed so that the selected group covers a substantial part of the grid. The text strings corresponding to the group may be displayed in text form.

In another aspect of the present invention, representations of the filtered text strings are displayed on a graph using lines extending between a plurality of vertical axes, each of the vertical axes representing an audit event parameter.

Embodiments of this aspect may include one or more of the following features. A group of displayed lines may be selected by selecting a point on one of the vertical axes. Only lines that pass through the selected point may be displayed. The text strings that correspond to the selected group of lines may be displayed in text form.

These and other objects, features, and advantages will be apparent from the following description of the preferred embodiments of the present invention.

### BRIEF DESCRIPTION OF THE DRAWINGS

The present invention will be more readily understood from a detailed description of the preferred embodiments considered in conjunction with the following figures.

FIG. 1 is a block diagram of a computer network having a log analysis sub-system in accordance with an embodiment of the present invention;

FIG. 2 is a block diagram of the log analysis sub-system and log collection module.

FIG. 3 is a listing of a system security log in text form.

FIG. 4 is the graphical interface used to visually represent log data.

FIG. 5 is a summary graph representation of log data.

FIG. 6 is a scatter-plot representation of log data.

FIG. 7 is a parallel coordinate representation of log data.

### DETAILED DESCRIPTION OF THE PREFERRED EMBODIMENTS

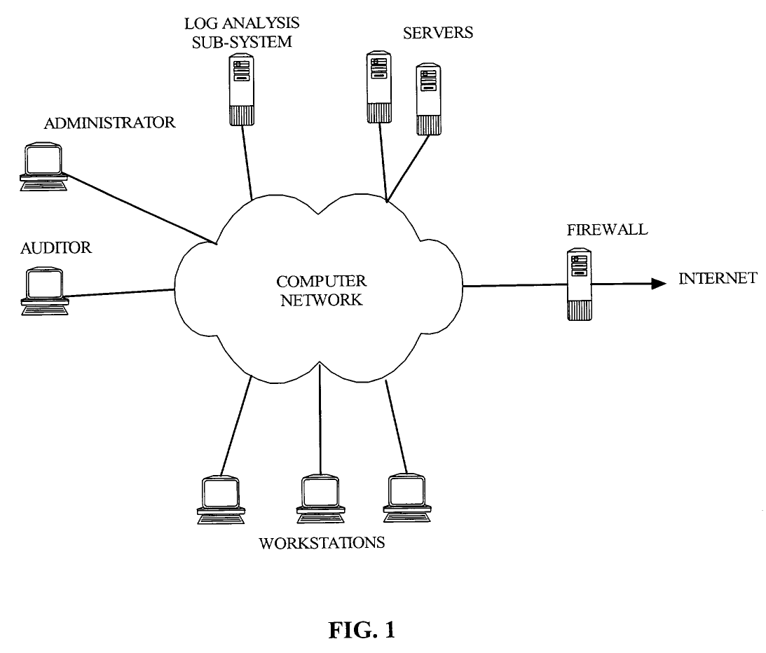

According to the present invention, as shown in FIG. 1, a log analysis sub-system is implemented in a computer network to allow log data from various sources in the network to be systematically accumulated and analyzed. In general, the network may be implemented using, for example, the IP protocols over Ethernet or Token Ring medium access protocols. The network may comprise a number of nodes such as servers, workstations and personal computers, routers, switches, wireless access points and other networking devices, firewall systems, intrusion detection systems, virtual private network concentrators and other information security devices.

The servers, which are network nodes configured to provide network services, such as mainframe computers, minicomputers running UNIX, Linux or Microsoft Windows™ operating systems, may have an auditing subsystem configured to collect and store auditable events in a system or security log. The workstations and personal computers, which are network nodes running Windows™ operating system that provide general purpose computing facilities and access to the computer network to legitimate users, network administrators, security administrators and security auditors, may have such an auditing subsystem to collect and store auditable events.

The network also may include routers, switches, wireless access points and other networking devices, which are network nodes that implement and manage connectivity and communications between network nodes, with auditing subsystems configured to collect and store auditable events in a security or system log. The network may also include firewalls, intrusion detection systems, virtual private networks concentrators and other information security devices, which are network nodes dedicated to implement, enforce and monitor information and network security policies in the network, with auditing subsystems configured to generate, collect and store information security auditable events in system and security logs.

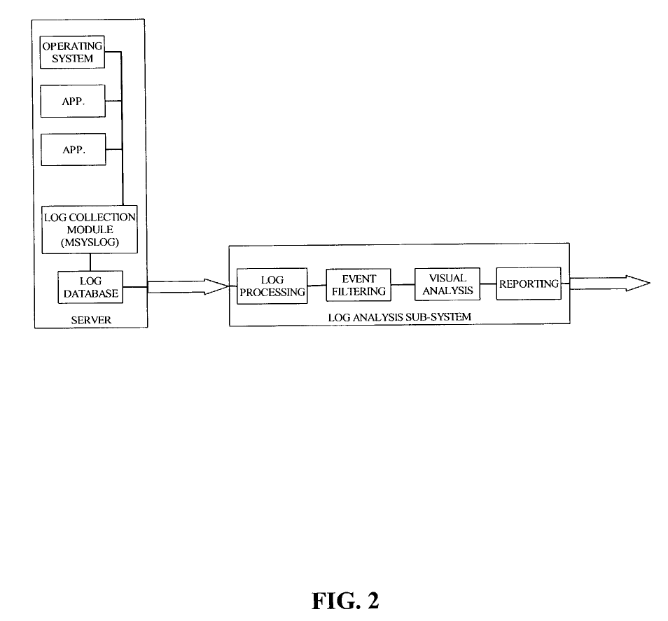

The log analysis sub-system may be configured as a dedicated server node in the computer network or, alternatively, may be configured to function on one of the existing network servers. As shown in FIG. 2, a log collection module, referred to as “msyslog”, collects log data from the auditing subsystem of the operating system and from various applications, referred to as “log sources”, running on any of the nodes of the computer network. The log data generated by these sources provides a record, i.e., an audit trail, of important events relating to the source, such as network transactions, error messages, and system events. The audit trail is used for various purposes, such as system troubleshooting and security auditing.

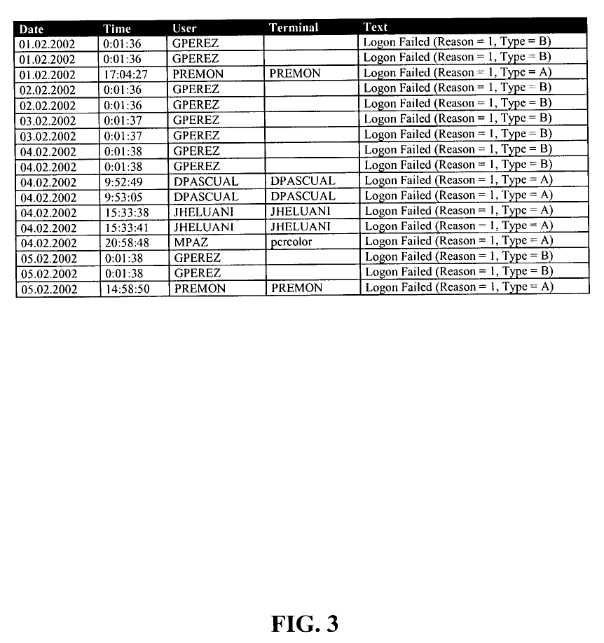

An example of a listing of a system security log in text form is shown in FIG. 3. The log details the date, time, username and terminal associated with each event and a description that identifies the type of event, e.g., log-in failure. The description may also include additional information about the event, such as the reason for the event, in the form of numeric or alphabetic codes.

The msyslog log collection module, is a replacement for the standard log collection tools provided as part of the auditing subsystems of computer network nodes such as syslog in nodes running the UNIX or Linux operating systems and Event Logger in nodes running the Microsoft Windows™ operating system. Msyslog is configured to receive and collect audit events from a variety of log sources, such as applications and operating system auditing subsystems and store them in a log database. The communication between the Msyslog and the various log sources may be encrypted and authenticated using standard techniques to ensure the security of the log data.

The log collection module can be configured to store log data in a log database present on a server network node where msyslog is running as shown in FIG. 2 or, alternatively, on a different network node, such as a server that provides data storage and management services to the other network nodes using a relational database engine.

Referring again to FIG. 2, data in the log database used by the log analysis sub-system where it is processed in a log-processing module. This module receives as input log data in the form of multiple text lines read from the log database and processes them by applying to them a set of pre-defined parsing rules that dictate how to interpret the format of the particular log database used as source of log data. These rules specify as well a mapping between log data and the auditable events they signal. The output of the log-processing module consists of a set of events, each one of them composed of an attribute and value pair, referred as “attribute-value tuple”, that can later be processed or displayed by other modules.

The use of parsing rules permits the processing of log data received from different applications and platforms with different proprietary formats. To construct the parsing rules needed to convert source text lines into the attribute-value pairs required for analysis, the auditor executes a two-level iterative definition process. The first level involves the classification of log data into application generated events. For each application, several second-level parsing rules can be defined to further extend the conversion of log-lines fields into attribute-values. To help in the development of the line-parsing rules, the auditor uses a graphical user interface to select lines unmatched by previously defined rules, highlight the text-fields associated with each attribute, and identify constant keywords. Additionally, the interface is used to specify the flow of log information from log collection sources, through different filters, and to log repositories.

An event-filtering module uses the output of the log-processing module to select and separate events based on conditions imposed to the attribute-value tuples of each event. Events whose attribute-value tuples match the given conditions are included in the set of outputs of the event-filtering module. The use of the event-filtering module allows the user to select and later analyze certain type of events that are relevant for specific information security goals, e.g., failed log-in attempts within the last week.

The visual analysis module uses the output from the event-filtering module to process events and allow the auditor an interactive navigation and analysis of the log data based on the graphical characteristics of different visual representations of event attribute-value tuples. The selection and interaction with the different visual representation of log data is done with graphical user interface (GUI) that will be described further below.

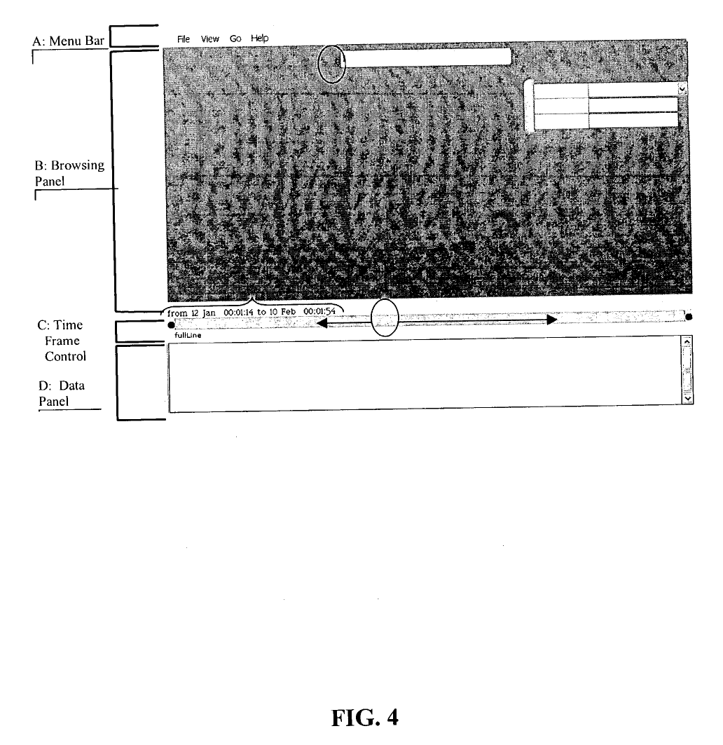

As shown in FIG. 4, the graphical user interface (GUI) used to visually represent the log data includes a visualization area that is divided into a number of sections. Each section displays data in a particular format or provides graphical interface control functions. The analysis section, which in this example is formed in the central portion of the screen, acts as the primary data display area by displaying a graphical representation of the log data being analyzed.

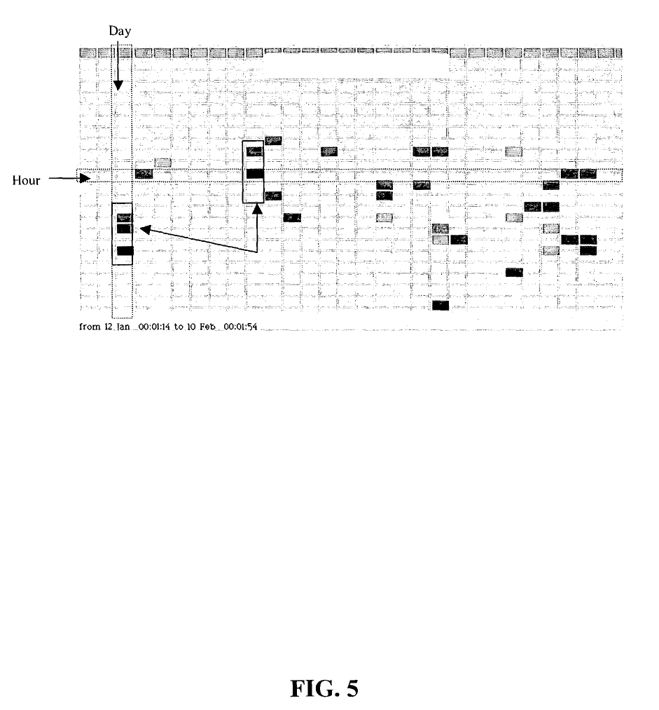

A summary graph, as shown in FIG. 5, is a graphical representation in which each column (x-axis) represents a time period and each row (y-axis) represents a smaller time period. This visual representation is particular useful to let the auditor identify re-occurring patterns of events. For example, in the daily view of FIG. 5, each column represents one day and each row represents one hour. Thus, each box on the graph represents the events occurring within an hour range in a particular day. Each rectangular space in the grid formed by the bi-axial summary graph is color-coded according to the total number of events occurring in the timeframe it represents. The summary graph can show, for example, the hourly rate of failed logons attempts in a month's period. The scale of the summary graph may be adjusted to allow the auditor to view a longer or shorter timeframe with greater detail. For example, in the weekly view, each column represents one week and each row represents one day, thus giving a more aggregated view of the log date summarized by event frequency. The summary view is thus useful for processing and visualizing large amounts of log data with a simple yet revealing graphical analysis capability.

Log events may be filtered to display only a subset of the accumulated events to allow the user to focus, for example, on particular types of events or time frames of interest. The user may select a group of displayed events in a particular time frame to be examined more closely by selecting them with the mouse. The selected events are displayed in text form in the data panel, which is located at the bottom the graphical interface below the analysis section. The selected events also may be used as the basis for rescaling the graph to show only the selected events, which in effect allows the user to “zoom in” on the selected events and view them in greater detail. Alternatively, the selected events may be used as the basis for opening a new graphical interface window to show the selected events, which allows the user to view the selected events in greater detail without changing the initial graph. The user also may select particular types of log events to examine more closely by selecting the event types on a menu display. Other criteria may be used to filter the events, such as user-name, terminal, etc.

The summary graph allows an auditor to analyze time patterns in the logged events. For example, a large number of logon failures at 12:00 AM each day may be due to an automated job running on the server that is failing due to logon errors, which would not raise security concerns. As a further example, a high concentration of logon failures during the morning of the first day of the week may be a typical usage pattern for a given organization and not raise security concerns. However repeated logon failure events at 4 am of a Saturday might immediately be distinguished as an abnormal pattern and raise security concerns of an attempted and possibly successful security breach by an external attacker.

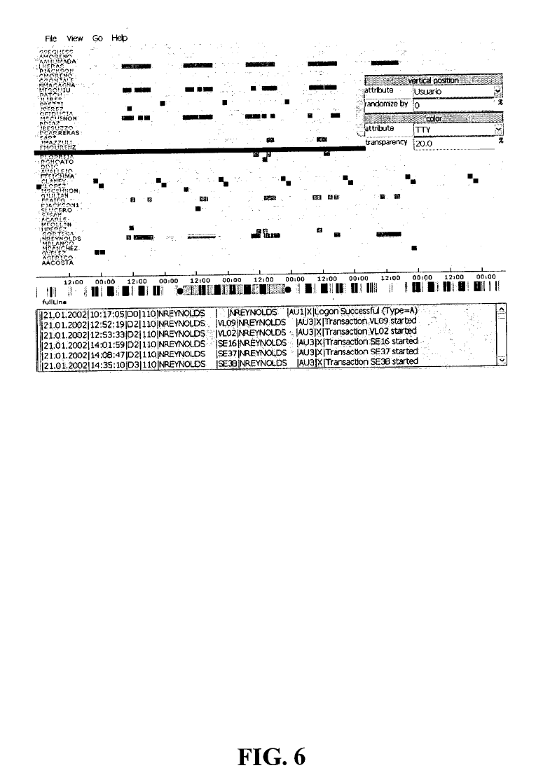

A scatter-plot graph, as shown in FIG. 6, is a graphical representation having time as the x-axis and another variable of interest as the y-axis. The user may select from among a number of possible variables for the y-axis, such as username, terminal, event type, etc. In the example of FIG. 6, usernames form the y-axis. This allows an auditor to analyze patterns in the events from the log database that relate to specific users. For example, the auditor might inspect the use of a “su” program in a UNIX operating system by legitimate users to switch access privileges to those of a more privileged system account such as root, in order to identify possible abuse of access rights. As with the summary graph, the user may select a group of displayed events by selecting them with the mouse.

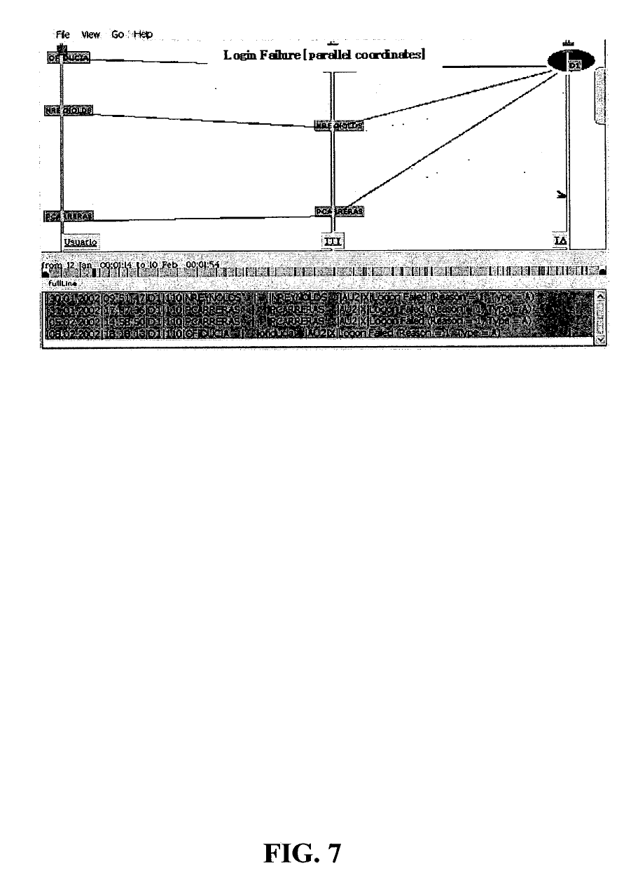

A parallel coordinate plot, as shown in FIG. 7, has multiple y-axes, which may be used to plot username, terminal, event type, etc. Each event is represented by a line that connects points on the axes. For example, a login failure for User A using Terminal B through Port 22 would be represented by a line connecting these points on the three respective axes. The user can select groups of records to analyze by clicking on a point on one of the three axes, for example, by clicking on a particular terminal on the terminal axis. This action highlights all of the events associated with that terminal and lists these events in text form in the data panel below the analysis section.

Referring again to FIG. 4, in addition to the graphical representations displayed in the analysis section, the graphical interface has other sections that provide information or allow control of the interface. The title section indicates the particular log that is the source of the data being analyzed, e.g., the operating system log. The title section also indicates the type of data format being used to present the data. A configuration section provides pull-down menus from which various settings relating to the interface can be selected, such as the selection of a daily or weekly view for a summary graph. The configuration section can be hidden from view by clicking on a control bar.

The time frame display shows the time interval spanned by the log data or the particular analysis time frame selected by the user. For summary or scatter-plot graphs, an event density section is provided, which is a horizontal bar that graphically represents the density of log events as a function of time, for example, by representing each log event as a vertical line. Sliding controls may be used to change the time frame under analysis, allowing the user to concentrate on a particular time frame of interest.

It will be appreciated that the system described above amplifies cognition of security vulnerabilities by providing a visual representation of log data in a form that allows human perception to be used to analyze the data. Using the visual representation, it may be possible to crystallize a multitude of log events into a pattern indicative of a security vulnerability. In addition, anomalous events that might be missed in a text-based log may be quickly identified due to the graphical approach of the analysis, in which each single event is considered as part of the complete activity of the systems in relation to all events taking place in a period of time. These advantages may lead to a higher-quality security analysis than one obtained from the text-based reports and traditional graphical approaches, such as pie and bar charts.

Another clear advantage of the visual representation is that while it is not natural for us to remember patterns expressed on a text list, it is fairly easy to remember spatial objects as pictures and maps or, in our case, visual diagrams based on event logs. Then anomalous behavior can be expressed as an event that occurs outside predefined limits (easy to recognize on the graph) or by a complete change of the normal pattern, with a very different “behavioral map” of the system activity. It is also important to note the iterative nature of the analysis, where each graphical construction on the logs can initiate a line of research to direct the analysis by visually navigating a specific timeframe in the log trails.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method for analyzing audit log data, comprising the steps of:
storing text strings from a plurality of devices in a log database, each of the text strings being indicative of an audit event in the respective device;
retrieving at least a portion of the text strings from the log database;
parsing the retrieved text strings according to pre-defined parsing rules;
mapping each of the retrieved text strings to a respective audit event;
filtering the retrieved text strings based on the respective audit event; and
displaying representations of the filtered text strings on a grid using color-coded areas, the horizontal axis of the grid representing a first time scale and the vertical axis of the grid representing a second time scale different from the first time scale.

2. The method of claim 1, further comprising the steps of:
selecting a group of the displayed areas;
rescaling the grid so that the selected group covers a substantial part of the grid; and
displaying the text strings corresponding to the group in text form.

3. A method for analyzing audit log data, comprising the steps of:
storing text strings from a plurality of devices in a log database, each of the text strings being indicative of an audit event in the respective device;
retrieving at least a portion of the text strings from the log database;
parsing the retrieved text strings according to pre-defined parsing rules;
mapping each of the retrieved text strings to a respective audit event;
filtering the retrieved text strings based on the respective audit event;
displaying representations of the filtered text strings on a graph using lines extending between a plurality of vertical axes, each of the vertical axes representing an audit event parameter.

4. The method of claim 3, further comprising the steps of:
selecting a group of displayed lines by selecting a point on one of the vertical axes;
displaying only lines that pass through the selected point; and
displaying the text strings that correspond to the selected group of lines in text form.
